(19) United States
(12) Patent Application Publication
(10) Pub. No.: US 2026/0025368 A1
(43) Pub. Date: Jan. 22, 2026

(54) LOAD DISTRIBUTION OF INTERNET PROTOCOL SECURITY TUNNEL FOR MULTICORE PROCESSING

(71) Applicant: CISCO TECHNOLOGY, INC., San Jose, CA (US)

(72) Inventors: Guillaume SOLIGNAC, Antony (FR); Mohsin Mazhar SHAIKH, Tampines (SG); Paul PONCHON, Paris (FR); Pierre PFISTER, Angers (FR); Hadi DERNAIKA, Massy (FR)

(21) Appl. No.: 18/778,256

(22) Filed: Jul. 19, 2024

(51) Int. Cl. H04L 9/40

(52) U.S. Cl. CPC H04L 63/0435; H04L 63/029; H04L 63/1466

(57) ABSTRACT

In one embodiment, a method includes receiving, by a first processor, a data packet for processing, the data packet including a header in an unencrypted portion of the data packet, the header having subspace ID information corresponding to a core from which the data packet was sent; saving, by the first processor, the subspace ID information; encoding, within the header, a selected subspace ID information identifying a core within the first processor to which subsequent data packets are to be received; and sending, by the first processor, in another data packet, the selected subspace ID information to a second processor that sent the data packet, the selected subspace ID information included in a header in an unencrypted portion of the data packet.

### FIELD

The present disclosure relates to data tunnels and more particularly to load distribution for processing data transmitted using Internet Protocol Security (IPsec) tunnels.

### BACKGROUND

IPsec is a set of communication rules or protocols for setting up secure (encrypted) connections over a network, such as virtual private networks (VPNs) across publicly shared networks. Data authentication can be provided between two communication points across an IP network using IPsec, which defines encrypted, decrypted, and authenticated packets. Anti-replay is a sub-protocol of IPsec used to prevent hackers from intercepting or resending packets (to inject or make changes to the packets) between network nodes to maintain data integrity.

Performing IPSec with anti-replay within multi-core environments where packets may be reordered can be complex and is difficult to scale. Accordingly, it is desirable to provide improved methods and systems for performing IPSec, particularly anti-replay, in multi-core environments. Furthermore, other desirable features and characteristics of the present disclosure will become apparent from the subsequent detailed description and the appended claims, taken in conjunction with the accompanying drawings and the foregoing technical field and background.

### DRAWINGS

In order that the disclosure may be well understood, there will now be described various forms thereof, given by way of example, reference being made to the accompanying drawings, in which:

FIG. 1 is a functional block diagram illustrating an example computing system having IPSec processing control in accordance with various embodiments.

FIG. 2 is a block diagram illustrating an IPSec Encapsulating Security Payload (ESP) header in accordance with various embodiments.

FIG. 3 is a diagram illustrating a subspace ID field of the IPSec Encapsulating Security Payload (ESP) header of FIG. 2.

FIG. 4 is a block diagram illustrating using anti-replay contexts in accordance with various embodiments.

FIG. 5 is a block diagram illustrating subspaces used for IPSec operations in accordance with various embodiments.

FIG. 6 is another block diagram illustrating subspaces used for IPSec operations in accordance with various embodiments.

FIGS. 7-9 illustrate packet flow of a method in accordance with various embodiments.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

According to various embodiments, systems, methods, and computer program products are provided for processing data packets. A method includes receiving, by a first processor, a data packet for processing, the data packet including a header in an unencrypted portion of the data packet, the header having subspace ID information corresponding to a core from which the data packet was sent; saving, by the first processor, the subspace ID information; encoding, within the header, a selected subspace ID information identifying a core within the first processor to which subsequent data packets are to be received; and sending, by the first processor, in another data packet, the selected subspace ID information to a second processor that sent the data packet, the selected subspace ID information included in a header in an unencrypted portion of the data packet.

### EXAMPLE EMBODIMENTS

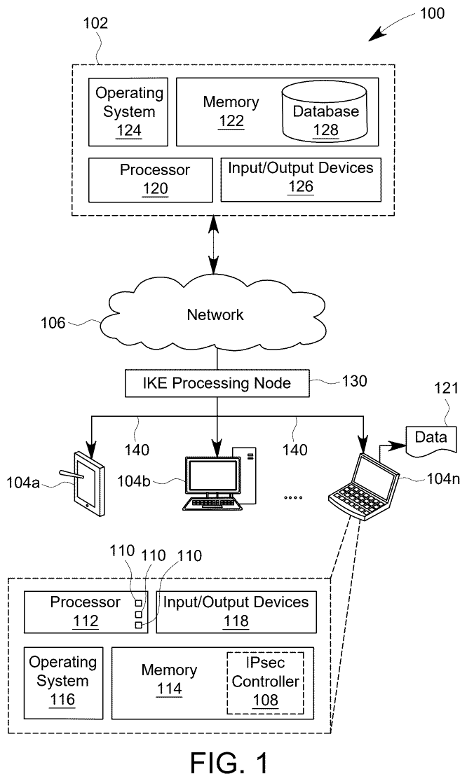

With reference to FIG. 1, an exemplary computer environment is shown generally at 100 having a server system 102 of one or more servers that are communicatively coupled to one or more computer systems 104a, 104b, . . . , 104n through a network 106. In some embodiments, the one or more computer systems 104a-104n connect to the network 106 (e.g., cloud network) through respective tunnels 140, such as virtual private network (VPN) or other data tunnels. The one or more computer systems 104a-104n generally operate with any sort of conventional processing hardware, including, but not limited to, at least one processor 112, memory 114, an operating system 116, and an input/output device 118.

The computer environment 100 is shown having an IPsec controller 108 that controls inner data flows within the tunnels 140 (defining outer flows) using a per-flow in-band subspace (or SA) flow-pinning as described in more detail herein, which in various embodiments adds four bytes protocol overhead as the sequence number field is changed to forty-eight bits from thirty-two bits and sixteen bits subspace ID field is added. For example, the various inner flows within the tunnels 140 are assigned to specific processing cores 110 (also referred to as cores 110) of the processor 112 when performing IPsec operations. In one or more embodiments, an AutoVPN arrangement is provided that uses a subspace ID (in an unencrypted portion of data packets) to split the load of a tunnel (e.g., any of the tunnels 140) between the cores 110. In operation, each subspace ID is processed on a selected or associated core 110 to avoid the processing overhead for processing the load on different cores (e.g., without synchronization), thereby improving overall IPsec performance. In some examples, moving packets across the cores 110 is thereby minimized or eliminated.

As can be appreciated, the IPsec controller 108 disclosed herein may be located on the computer systems 104a-104n, located on the server system 102, located on a device or node of the network 106, or distributed between any of the server system 102, the computer systems 104a-104n, and one or more devices or nodes of the network 106, or other systems. For exemplary purposes, the disclosure will be discussed in the context of the IPsec controller 108 being implemented on one of the computer systems 104a-104n.

In various embodiments, the server system 102 stores and makes available different content to users of the computer environment 100. In some instances, the content may include data 121 attempting replay attacks or other attacks against the computer systems 104a-104n. The server system 102 generally operates with any sort of conventional processing hardware, including, but not limited to, at least one processor 120, memory 122, an operating system 124, an input/output device 126, and a database 128 that stores content (e.g., web content).

The processors 112, 120 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 114, 122 represents any non-transitory short- or long-term storage or other computer-readable media capable of storing programming instructions for execution on the processors 112, 120, including any sort of random-access memory (RAM), read only memory (ROM), flash memory, magnetic or optical mass storage, and/or the like. The computer-executable programming instructions, when read and executed by the processors 112, 120, cause the processors 112, 120 to create, generate, or otherwise facilitate the communication of content and perform one or more additional tasks, operations, functions, and/or processes described herein. In various embodiments, the memory 114 includes the IPsec controller 108 (which may also be implemented as separate hardware or software) and the memory 122 includes the database 128 that stores the content. As can be appreciated, the memory 114, 122 represents one suitable implementation of such computer-readable media, and alternatively or additionally, the processors 112, 120 could receive and cooperate with external computer-readable media that is realized as a portable or mobile component or application platform, e.g., a portable hard drive, a USB flash drive, an optical disc, or the like.

The operating systems 116, 124 includes computer-executable programming instructions, when read and executed by the processors 112, 120, cause the processors 112, 120 to operate the computer system's basic functions such as scheduling tasks, executing applications, memory allocation, and controlling the input/output devices 118, 126. The input/output devices 118, 126 generally represent the interface(s) to networks (e.g., to the network 106, or any other local area, wide area, or other network), mass storage, display devices, data entry devices, and/or the like.

In various embodiments, the network 106 generally includes interconnected network nodes that are arranged according to one or more of a variety of network topologies and that are configured to communicate data according to one or more communication protocols. The network nodes can include, for example, network interface controllers, repeaters, hubs, bridges, switches, routers, firewalls, modems, etc. The network nodes may be interconnected based on physically wired, optical, and/or wireless topologies.

Each of the one or more computer systems 104a-104n (referred to generally as computer system 104) generally includes any sort of personal computer, mobile telephone, tablet, or other network-enabled client device on the network 106. The computer system 104 generally operates with any sort of conventional processing hardware, including but not limited to, the at least one processor 112, the memory 114, the operating system 116, and the input/output devices 118. The processor 112 may be implemented using any suitable processing system, such as one or more processors, controllers, microprocessors, microcontrollers, processing cores 110 and/or other computing resources spread across any number of distributed or integrated systems, including any number of “cloud-based” or other virtual systems.

In an exemplary embodiment, the computer system 104 includes or communicates with a display device, such as a monitor, screen, or another conventional electronic display capable of presenting the web content retrieved from the server system 102 or other internet device via the network 106.

According to one or more use cases, and for example, a user operates a conventional application (e.g., browser application) or other client program such as an application executed by the computer system 104 to contact the server system 102 via the network 106 using a networking protocol, such as the hypertext transport protocol (HTTP) or the like. Dynamic web or other content is then presented and viewed by the user, as desired, via the display device. In various embodiments, the IPsec controller 108 operates on the data communicated via the inner tunnels of the tunnels 140 to split the IPsec processing among the cores 110.

It should be appreciated that the network 106 can include any type of network, infrastructure, or set of systems that may be associated with the delivery of computing and storage capacity for any number of end users or for network devices. For example, an end user (or a network device) can access a cloud-based application through a web browser, a mobile app, a tunnel, etc. In some embodiments, the computer systems 104 connect to the network 106 through respective tunnels 140 (e.g. VPN tunnels) and an Internet Key Exchange (IKE) processing node 130 may offload IPSec processing of the tunnels 140 to one or more of the cores 110 as described in more detail herein. The IKE processing node 130 in one or more embodiments enables secure delivery of content to the computer systems 104 by splitting the load between the different cores 110 for IPsec processing, such as anti-replay processing. Any number and variety of computer systems 104 may connect to the network 106 to access data, services, etc. The computer systems 104 may be associated with, for example, enterprises/departments/remote offices, mobile individual users with networking software clients installed on mobile devices, such as laptops, remote teleworkers/home office, etc.

As described in more detail herein, the computer systems 104 can connect to the network 106 over the respective tunnels 140, which are VPN tunnels in some examples. As used herein, a “VPN tunnel” is a communications channel between two nodes that transports data by encapsulating the data's Internet Protocol (IP) packets according to any suitable cryptographic tunneling protocol. A node can be any electronic device, client, server, peer, service, application, or other object capable of sending, receiving, or forwarding information over communications channels in a network. Cryptographic tunneling protocols may include without limitation, Internet Protocol security (IPsec), Secure Socket Layer/Transport Layer Security (SSL/TLS), Datagram Transport Layer Security (DTLS), Microsoft Point-to-Point Encryption (MPPE), and Secure Shell (SSH).

It should be appreciated that one or more herein described embodiments can be implemented with different network capabilities (e.g., cloud capabilities), such as, but not limited to, the (a) capability to support different multicast encryption schemes; (b) capability to encrypt Layer 2 tunneling protocol (L2TP) version 2, or L2TPv3 tunnels; (c) capability to encrypt Generic Routing Encapsulation (GRE) tunnels; (d) capability to encrypt IPv6 traffic; (e) capability to provide different quality of service (QOS) for IPsec; (f) capability to support different VPN technologies including EzVPN, dynamic multipoint VPN (DMVPN), and group encrypted transport VPN (GETVPN); (g) capability to support IKEv2; (h) capability to support mobility including mobile VPN client and home agent/foreign agent (HA/FA); (i) capability to support Lempel-Ziv-Stac (LZS) compression before encryption; (j) capability to support data encryption standards (DES)/Triple DES (3DES)/Advanced Encryption Standard (AES) 256; (h) capability to support hot standby routing protocol (HSRP); (k) capability to support IPsec with network/port address translation (NAT/PAT), etc. In some embodiments, the capabilities may also include functions such as encryption, decryption, specialized routing, intrusion management, accounting, and other layer 3 through layer 7 applications that may reside on top of layer 2 switching and/or layer 3 routing services.

As will now be described in more detail, in one or more embodiments of the computer environment 100, the IKE processing node 130 may offload the tunnels 140, and particularly data processing within inner tunnels of the tunnels 140, for IPSec processing. As used herein, the term “offload” includes transferring data from one network element (e.g., the IKE processing node 130) to another network element (e.g., the cores 110). More specifically, the offloading can include transferring (or distributing) processing responsibilities between devices, or across multiple processors (e.g., cores 110) of a single device. This can allow, for example, one network device to receive and to accommodate additional flows, as the processing cycles (that the network device would otherwise be responsible for) are being performed by another network device. The offloading can further include transferring data within inner tunnels of certain VPN tunnels to a different network device, which may be more capable of processing certain types of flows.

In various examples, one or more of the computer systems 104a-104n include hardware and associated software/firmware to support different capabilities, including providing cryptographic functions such as IPsec processing, encryption, decryption, key generation, and hashing, among others. In various embodiments, the IPsec controller 108 sets only part of the subspace ID when sending data packets and keeps a part available to specify a receiver thread ID as described in more detail herein. For example, the receiver thread ID is set to 0 (or to a pseudo-randomly selected value based on the hash of the flow key, or any other value) when there is no information on this flow initially, and is thereafter set upon receiving a packet for this flow. That is, each peer (e.g., computer system or device) allows the other peer to decide where that peer wants to receive this flow.

It should be appreciated that different types of processing and communication protocols may be used by the computer environment 100. For example, different types of cloud computing environments may be implemented, with a cloud deployment, such a private cloud (e.g., enterprise network), or a data center (DC) in a public cloud (e.g., Internet) that can include thousands of servers (or alternatively, VMs), hundreds of Ethernet, Fiber Channel or Fiber Channel over Ethernet (FCOE) ports, switching and storage infrastructure, etc. The cloud can also consist of network services infrastructure like IPsec VPN hubs, firewalls, load balancers, wide area network (WAN) optimizers etc. Remote subscribers can access the cloud applications and services securely by connecting via a VPN tunnel, such as an IPsec VPN tunnel corresponding to the tunnels 140.

In various embodiments, the IPsec controller 108 is operable with an IPsec based VPN protocol made up by two parts: (i) IKE protocol and (ii) IPsec protocols. The first part, IKE, is the initial negotiation phase, where two VPN peers (e.g., routers) agree on the methods that may be used to provide security for the underlying IP traffic and define the security associations (SAs) for the connection. When the IKE negotiation begins, in some examples, the peer (e.g., router at the subscriber) that initiates the negotiation sends all IKE policies (e.g., combination of security parameters to be used during the negotiation) to the remote peer (e.g., gateway at the cloud). The IKE processing node 130 at the remote peer looks for a policy match by comparing its own IKE policies against the IKE policies received from the initiating peer. IPsec SAs may be negotiated using the Internet Security Association and Key Management Protocol (ISAKMP) promulgated by the Internet Engineering Task Force (IETF). The ISAKMP format provides a framework for transferring key and authentication data independent of any key generation technique, encryption algorithm and authentication mechanism. An ISAKMP message has a header format, followed by a variable number of payloads. The header contains fields carrying information required by the protocol to maintain state, process payloads and prevent denial of service or replay attacks in various embodiments.

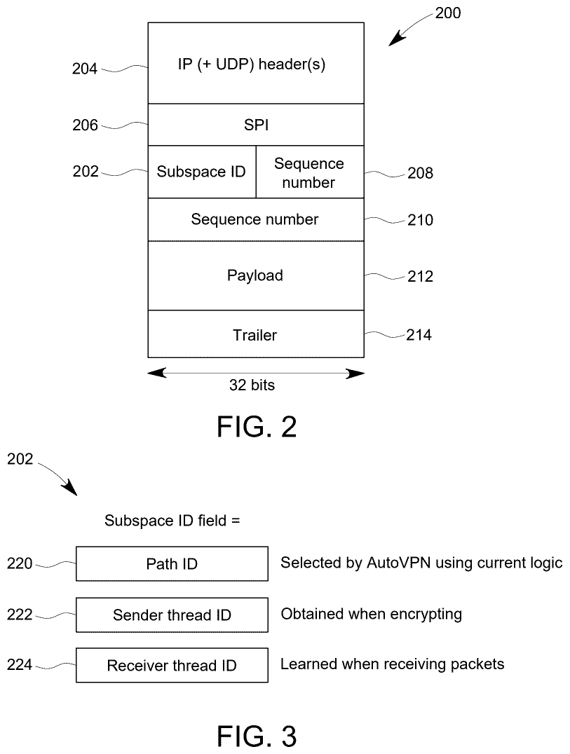

More particularly, and with reference to FIGS. 2 and 3, an IPSec Encapsulating Security Payload (ESP) header 200 is shown that includes a subspace ID field 202. The IPsec ESP header 200 is used to route data over an IPsec network, such as provided by the computer environment 100. For example, the computer environment 100 transmits data in the form of packets, with each packet having a specific format. The IPsec ESP header 200 is used with IPSec to provide infrastructure for supporting secure IP communications by encrypting and/or authenticating IP data packets, to thereby provide a virtual path or IP tunnel, such as one or more of the tunnels 140, within the IP network. In the illustrated example, the IPsec ESP header 200 also includes one or more IP (+User Datagram Protocol (UDP)) headers 204, a security parameter index (SPI) 206, a sequence number 208 associated with the subspace ID field 202, a sequence number 210, a payload 212, and a trailer 214. In some examples, the various fields of the IPsec ESP header 200 are each thirty-two bits in length. However, different lengths of fields can be used.

In operation, once the security features have been provided to data packets, the data packets are transmitted over the IPSec ESP tunnel, such as one or more of the tunnels 140. The sequence number for each packet is allocated according to the order of processing and servicing the packet, such as in a traffic management module, and as the packets are provided in this order to a post-queue line interface, the packets are transmitted over the IP tunnel in the order of sequence numbers. Inbound packets are received in the format shown in FIG. 2 and the header information within the IPsec ESP header 200 is accessed (e.g., selectors from the packet are used to access information through a lookup which returns a pointer to a security associated (SA) database and/or a security policy database (SPD)). The information may, for example, include: Source and Destination Address (a sending destination) from an outer IP header, Protocol from the outer IP header, the SPI 206 from the IPsec ESP header 200, and the subspace ID field 202 from the IPsec ESP header 200. The data packet can be validated in this way and using, for example, the SA database with the SA pointer.

In some examples, the sequence number 208, 210 from the packet is verified number against an anti-replay window (e.g., left edge of the anti-replay window) and against the anti-replay bitmap, which is processed in coordination with a selected core 110 as described in more detail herein. This process is used to confirm that the packet is not a duplicate packet or too old (e.g., exceeds a defined time period). In some examples, in response to the packet being a duplicate packet or too old, the packet is sent to a network processing module with proper indication and without further processing.

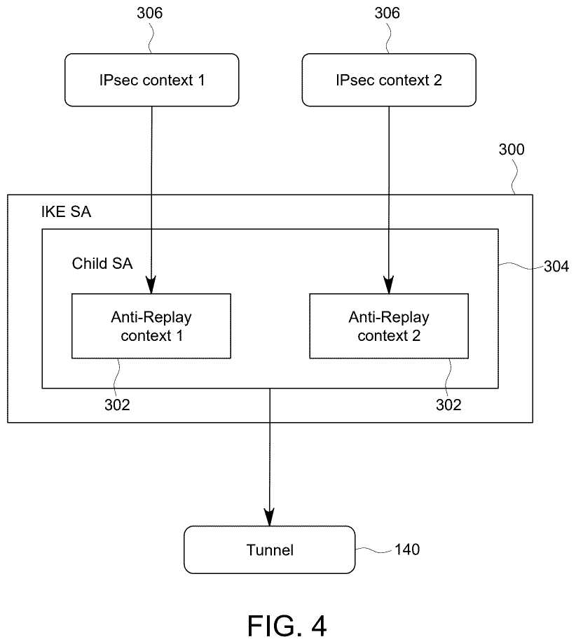

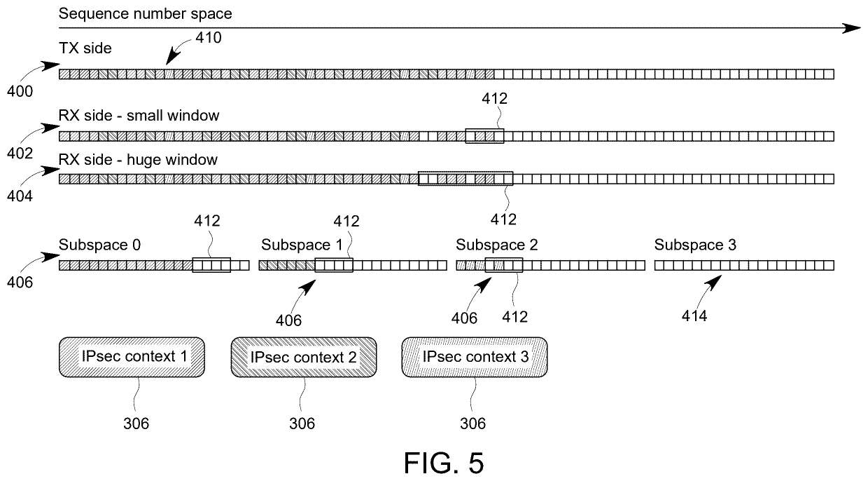

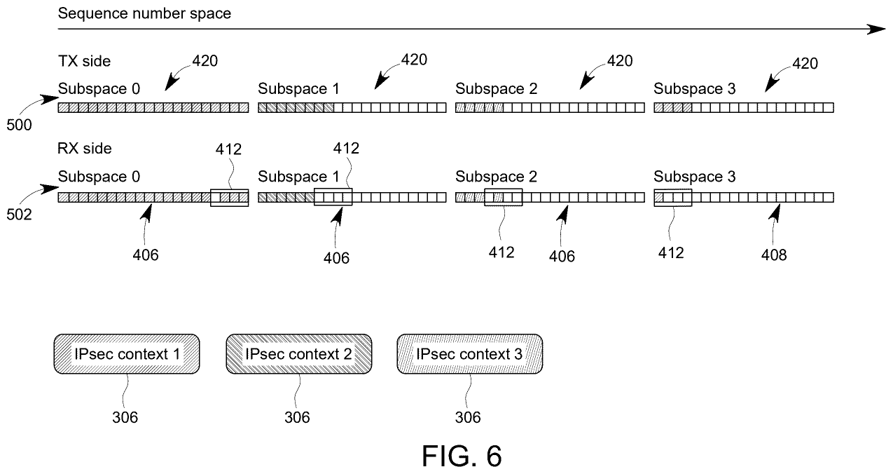

As shown in FIG. 4, an IKE SA 300 uses, in some embodiments, different anti-replay contexts 302 (Anti-Replay context 1 and Anti-Replay context 2) as part of a child SA 304 and in response to different IPsec contexts 306 (IPsec context 1 and IPsec context 2) to perform anti-replay operations for the data communicated over the tunnel 140. It should be noted that while two IPsec contexts 306 are illustrated, additional IPsec contexts 306 can be used as illustrated in FIGS. 5 and 6 showing the sequence number space. Data packets 410 on the transmit side 400 are processed upon receipt on the receive side 402, 404 using anti-replay windows 412. As can be seen in FIG. 5, the anti-replay windows 412 are different in size (a smaller window (shorter length) for the receive side 402 than the receive side 404). In this example, the processing of the IPsec contexts 306 is split based on subspaces 406 (illustrated as Subspaces 1, 2, and 3) on the receive side, using the subspace ID field 202, to identify the core 110 to be used to perform the anti-replay or other crypto-operations as described in more detail herein. As can be seen, the subspace 414 (Subspace 3) is not initially used and can be later used to specify a received thread ID. For example, as can be seen in FIG. 6, subspaces 420 on the transmit side can be used to identify or select subspaces 406, 408 for selecting cores 110 to perform anti-replay operations using the anti-replay windows 412, which now includes the anti-replay window 412 for the subspace 408.

The subspaces are selected using the subspace ID field 202, which in some examples includes a Path ID 220, a Sender thread ID 222, and a Receiver thread ID 224 (see FIG. 3). In one or more embodiments, the Path ID 220 is selected by an Auto VPN using selection logic (e.g., a learning based mechanism, such as implemented with machine learning or artificial intelligence), the Sender thread ID 222 is obtained when the data packets are encrypted, and the Receiver thread ID 224 is learned (e.g., identified) when receiving the data packets (e.g., the subspace ID for a particular core 110 is encoded within the IPsec ESP header 200 using the Subspace ID field 202). As such, the IPsec or other cryptographic operations are split on a multi-core processor, such as the processor 112 using information in an unencrypted portion of the data packet. With the herein described subspace approach of various embodiments, the tunnels 140 can be scaled linearly across the cores 110, which avoids or reduces the re-steering of data packets and avoids or reduces packet loss when using multiple uplinks.

Thus, in various embodiments, an AutoVPN approach is implemented that uses the subspace ID to split the load of the tunnel 140 between the cores 110. In operation, each subspace ID is processed on a selected core 110 (based on the subspace ID field 202), to avoid processing on different cores 110. In a software data plane, for a given flow, which can be defined by, for example, a 5-tuple, the flow can be processed on a core, such as a core-s-n (sender n). When a flow is to be sent on a tunnel, for example the tunnel 140, using the subspaces, in some examples, one subspace is associated per-core, and the subspace can be selected corresponding the core-s-n. It should be noted that one or more embodiments can similarly be implemented using N different SAs, and then selecting one of the SAs.

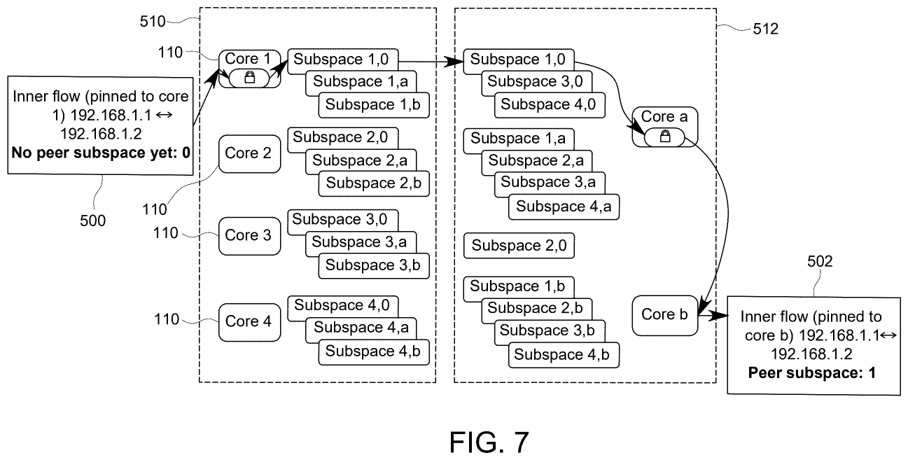

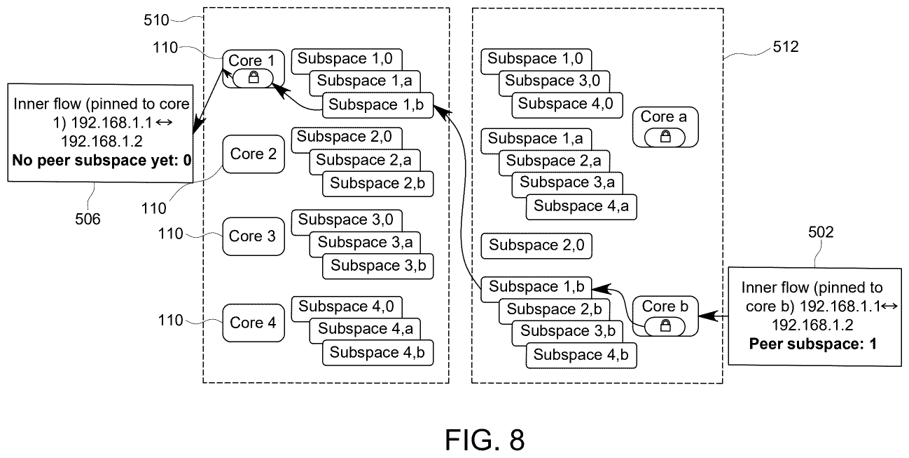

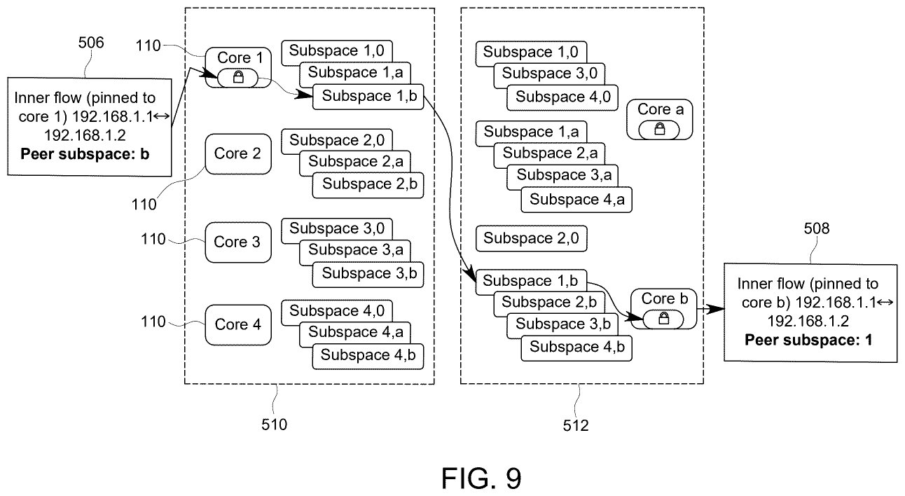

The IPsec controller 108 in various embodiments, when the packet is received, facilitates controlling which core 110 to which the subspace is assigned. Without the control, for example, if the inner flow inside the tunnel 140 is pinned on a different thread than the SA, the packet would have to be handed off to a different thread and the decryption work cannot be parallelized on a different thread. With one or more embodiments, as illustrated in FIGS. 7-9, a method is performed wherein only part of the subspace ID is set when sending the data packets and a part of the subspace ID is still available to specify a receiver thread ID. For example, as described herein, the receiver thread ID is set to 0 (or to a pseudo-randomly selected value based on the hash of the flow key, or any other value to set the initial subspace) when there is no information on this flow, and is thereafter set upon receiving a packet for this flow. As such, decryption is split across the cores 110 depending on the inner flows. In some examples, with RSS configurable on the subspace field, the receiver thread ID can be used to directly steer traffic on the receiver thread, avoiding packet handoff. In this case, an initial step is performed, for instance using IKE, to negotiate how many receive subspaces are needed on each peer. In one or more embodiments, for example, protocol processing is performed on a single core 110 and cryptographic processing is performed on multiple cores 110.

More particularly, the subspace ID is split into a receiver-core-ID field, and send-core-ID field, which may be of different sizes, and can be provided as part of the subspace ID field 202 as described in more detail herein. It should be noted that both peers are configured with the other peer's size for the field, which can be provided, using for example, IKE. When receiving a packet, by looking at the sender-core-ID in the IPsec packet, a peer will know what receiver-core-ID to use when sending a packet for the same inner flow to the remote peer. As can be seen, when data is initially sent by a peer 510, inner flow information 500 does not have a peer subspace identified or selected (and is not pinned to the core). Upon receipt of the data by a peer 512, the inner flow information 502 is updated, such that the inner flow is pinned to core b and the peer subspace is identified (subspace 1). That is, the inner flow information 502 is updated to have the cryptographic processing performed on core b of the peer 512 (and the peer subspace 1), which is then communicated to core 1 of the peer 510 using the inner flow information 502. In response, the inner flow information 506 is updated by the peer 510 to send the data to core b of the peer 512, which performs cryptographic processing using core b and the updated flow information 508 that identifies core 1 of the peer 510. As such, encrypted packets associated with an inner flow are always received and decrypted on the core to which the flow is currently attached (using the subspace ID as described herein). Thus, while the initial data transmission is to a random core 110 in various examples, with the use of the subspace ID information provided between peers, packets to be cryptographically processed can have the core 110 used for the processing identified before any decryption occurs.

Thus, in various embodiments, an encrypted packet, associated with an inner flow, is always received and decrypted on the core to which the flow is currently attached.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for processing data packets, the method comprising:
receiving, by a first processor, a data packet for processing, the data packet including a header in an unencrypted portion of the data packet, the header having subspace ID information corresponding to a core from which the data packet was sent;
saving, by the first processor, the subspace ID information;
encoding, within the header, a selected subspace ID information identifying a core within the first processor to which subsequent data packets are to be received; and
sending, by the first processor, in another data packet, the selected subspace ID information to a second processor that sent the data packet, the selected subspace ID information included in a header in an unencrypted portion of the data packet.

2. The method of claim 1, further comprising receiving, at the second processor, the selected subspace ID information and storing the selected subspace ID information.

3. The method of claim 2, further comprising transmitting, from the second processor, another data packet to the core associated with the selected subspace ID information.

4. The method of claim 1, wherein the subspace ID information and the selected subspace ID information are encoded with a subspace ID field of the data packets.

5. The method of claim 4, wherein the subspace ID field comprises a path ID, a sender thread ID, and a receiver thread ID.

6. The method of claim 1, further comprising performing IPsec operations using the identified core within the first processor.

7. The method of claim 6, further comprising dynamically updating the core for performing IPsec processing based on the subspace ID information.

8. A method for processing data packets, the method comprising:
using, by a processor, subspace ID information to encode a processing core on each side of a data tunnel, wherein the subspace ID information is encoded within an unencrypted portion of the data packets and identifies a sending destination for each side of the data tunnel; and
communicating the data packets between the processing core on each side of the data tunnel using the subspace ID information.

9. The method of claim 8, further comprising dynamically updating the subspace ID information to change the processing core on at least one side of the data tunnel.

10. The method of claim 8, wherein the processing core on each side of the data tunnel performs IPSec processing.

11. The method of claim 8, further comprising, setting, by the processor, an initial subspace based on a randomly selected value based on a hash of a flow key.

12. The method of claim 8, wherein the data tunnel comprises an IPsec tunnel, wherein protocol processing is performed on a single core and cryptographic processing is performed on multiple cores.

13. The method of claim 12, further comprising splitting, by the processor, anti-replay operations using the subspace ID information.

14. The method of claim 8, wherein the subspace ID information is encoded with a subspace ID field of the data packets, wherein the subspace ID field comprises a path ID, a sender thread ID, and a receiver thread ID.

15. The method of claim 8, further comprising performing IPsec operations using the processing core on each side of the data tunnel based on the subspace ID information.

16. The method of claim 8, further comprising dynamically updating the processing core for performing IPsec processing based on the subspace ID information.

17. A system for processing data packets, comprising:
a plurality of processors; and
a non-transitory computer-readable storage medium storing instructions which, when executed by the plurality of processors, cause the plurality of processors to:
use subspace ID information to encode a processing core of a processor on each side of a data tunnel, wherein the subspace ID information is encoded within an unencrypted portion of the data packets and identifies a sending destination for each side of the data tunnel; and
communicate the data packets between the processing core of the processor on each side of the data tunnel using the subspace ID information.

18. The system of claim 17, wherein the processing core on each side of the data tunnel performs IPSec processing.

19. The system of claim 17, wherein the non-transitory computer-readable storage medium storing instructions which, when executed by the plurality of processors, further cause the plurality of processors to set an initial subspace based on a randomly selected value based on a hash of a flow key.

20. The system of claim 17, wherein the data tunnel comprises an IPsec tunnel and protocol processing is performed on a single core and cryptographic processing is performed on multiple cores of the plurality of processors.
